(19) United States
(12) Patent Application Publication
(10) Pub. No.: US 2012/0183374 A1
(43) Pub. Date: Jul. 19, 2012

(54) PRODUCTION OF BOUND PAPER PRODUCTS

(75) Inventor: Ferdinand FUCHS, Lenningen (DE)

(73) Assignee: KUGLER-WOMAKO GMBH, Nuertingen (DE)

(21) Appl. No.: 13/346,162

(22) Filed: Jan. 9, 2012

(30) Foreign Application Priority Data
Jan. 10, 2011 (DE) 10 2011 002 490.5

(51) Int. Cl. B42B 5/10; B42C 19/08

(52) U.S. Cl. 412/7; 412/38

(57) ABSTRACT

Method and apparatus for producing bound flat parts, each having a sheet stack. Method includes conveying unbound sheet stack from sheet stack dispensing device into cassette of circulating conveyor, so that sheet stack is received into cassette, after receiving sheet stack in the cassette, driving circulating conveyor so cassette with sheet stack is conveyed to binding apparatus, and binding sheet stack in cassette at binding apparatus so that fingers formed as binding tongues are disposed in perforations so fingers are curved in the shape of a spiral. At least one of: adhesive-free area of each finger brought into overlapping contact with area of respective finger, adhesive-free area of each finger brought into overlapping contact with area of respective finger provided with adhesive, and overlapping contact areas of fingers are bound together. Removing at a dispensing station bound sheet stack from cassette, and delivering empty cassette to sheet stack dispensing device.

### CROSS-REFERENCE TO RELATED APPLICATIONS

The present application claims priority under 35 U.S.C. §119(a) of German Patent Application No. 10 2011 002 490.5 filed Jan. 10, 2011, the disclosure of which is expressly incorporated by reference herein in its entirety.

### BACKGROUND OF THE INVENTION

1. Field of the Invention

The invention relates to a method and an apparatus for producing bound flat parts, each having a sheet stack, particularly paper products.

2. Discussion of Background Information

Blocks or stacked flat parts made of paper or the like, such as brochures, user's guides, calendars, and writing pads, are bound with a binding comb or the like if they need to be opened easily.

Moreover, it is known to bind together paper stacks such as writing pads or notepads on one side using adhesive strips or wire combs or the like.

For instance, European Patent No. EP-B-0 704 322 describes a binder comb for holding together a sheet stack, where the spine part and fingers of the binder comb are disclosed as a single layer one-piece plastic binding which is produced by injection molding. The disclosure of this document is expressly incorporated by reference herein in its entirety.

Beyond that, International Publication No. WO-A-2006/090644 further discloses a multi-layer, one-piece paper comb binding having ring-shaped loops. The disclosure of this document is expressly incorporated by reference herein in its entirety.

### SUMMARY OF THE EMBODIMENTS

Based on this state of the art, embodiments of the invention provide a simple production of paper layers or paper stacks, where it must be possible to provide a variably configurable and/or variably producible binding.

Accordingly, embodiments are directed to a method for producing bound flat parts, each having a sheet stack, particularly paper products, where

a) an unbound sheet stack having a plurality of flat parts is supplied from a sheet stack dispensing device into a cassette of a circulating conveyor, where the sheet stack is received in the cassette,

b) after receiving the sheet stack to be bound in the cassette, the circulating conveyor is driven so that the cassette with the sheet stack is conveyed further, and in a further method step, the cassette with the sheet stack is delivered to a binding apparatus,

c) the sheet stack in the cassette is bound at the binding apparatus in such a way that fingers, designed as binding tongues, are disposed in perforations of the sheet stack, preferably provided with perforations, wherein the fingers are curved in the shape of a spiral, wherein a preferably adhesive-free area of the finger is, in each case, brought into overlapping contact with an area of the respective finger, preferably provided with adhesive, and/or wherein the overlapping contact areas of the fingers will be, or are, bound together, preferably permanently,

d) and in a subsequent method step, at a dispensing station, constructed at or adjacent to the circulating conveyor, the bound sheet stack is removed from the cassette, and in a further subsequent step, the empty cassette is delivered to the sheet stack dispensing device.

Embodiments of the invention is based on the idea that a sheet stack comprised of flat parts stacked on top of each other, is bound in an automated process using a circulating conveyor that can be designed as a rotary indexing table. After the transfer and arrangement of a sheet stack into a cassette of the circulating conveyor, the cassette with the sheet stack is further transported to a binding apparatus, so that a plurality of binding tongues or fingers are inserted into the perforations of the sheet stack. The fingers are rolled up loop-like and are each connected together in a contact area of the developed loop.

In the process, the binding tongues or the fingers in the overlapping contact area are designed in the manner of a simple roll or a multiple spiral-shaped rolling. A type of single loop or multiple loop, in particular double loop, is hereby formed. Preferably, the sheet stack is bound forming multiple, binding loops disposed next to each other, wherein the ends of the binding fingers or bindings are, or will be, connected together with a base sheet of the sheet stack.

In the scope of the invention it is possible that fingers designed as binding tongues are disposed at an outer sheet or base sheet so that an outer sheet having fingers disposed thereon is provided at the binding apparatus. In an alternative embodiment, the fingers are disposed individually in the perforations of the sheet stack provided with the perforations, and subsequently the ends of the fingers are bound to an outer sheet or base sheet of the sheet stack.

Thus, a rolled up loop binding, for example for calendars or for writing pads, is developed in one or more method steps at the binding device, wherein the loop binding is produced from the same material, for example paper or cardboard, as the material of the entire outer sheet or the base sheet or cover sheet. In particular, this type of single material binding as a comb binding or also as a multiple loop binding is formed according to the requirements with respect to the binding. Moreover, the comb binding or loop binding can be a part of the outer sheet or respectively the base sheet or the cover sheet having separate fingers arranged thereon, and can thus have multiple pieces, since the outer sheet is provided with further pieces in the form of fingers.

The cassettes of the circulating conveyor are designed to receive paper stacks, which are formed from a plurality of a flat parts or sheets (sheets of paper, for example) stacked on top of each other. Preferably, the cassettes, which have a bottom, have a placement side, against which the binding side of a sheet stack to be bound is placed, and are designed having side guides or guides positioned parallel to each other disposed on the sides at the placement side, and the distance between guides to each other can be adjusted so that the cassettes are open on one side and the top.

In performing the method, a counted, predetermined number of flat parts are placed into a cassette at a sheet stack dispensing device such that the cassette is delivered to the sheet stack dispensing device. Here, it is possible that flat parts provided with perforations are placed into the cassette as a sheet stack. In another embodiment it is also possible that an unperforated sheet stack with a predetermined number of flat parts is placed into the cassette, and in a further method step is provided with perforations before delivery to the binding apparatus.

After producing the spiral shaped loop binding or loop-shaped bindings through the individual fingers that are inserted into the perforations of the sheet stack, in a subsequent method step, the cassettes are emptied in or at the delivery station, so that for example, the finished bound sheet stacks are given to a discharge device such as a conveyor belt or the like.

For this purpose, in one embodiment of the method, the cassette after receiving a sheet stack and before delivery of the cassette to the binding apparatus, is delivered to at least one placement device, so that at least one sheet will be added to the sheet stack by the placement device. Preferably, the cassette is delivered, sequentially, preferably stepwise, to a plurality of placement devices, in particular a cover sheet placement device for placing a cover sheet and/or a base sheet placement device for placing a base sheet. Thereby, due to the one or more placement devices provided at the circulating conveyor, appropriate flat parts or sheets are arranged or placed on the sheet stack already disposed in the cassette of the circulatory conveyor, so that it is possible to place on, or to arrange on, the sheet stack, for example, an advertisement sheet or the like, using a placement device, or a cover sheet by using a cover sheet placement device, and/or then a base sheet by using a base sheet placement device. If both the sheet stack and the sheets or flat parts placed thereon are not perforated, then a punch device or perforation device can be provided in the conveyance direction of the cassette after the at least one placement device, such that the sheet stack provided with placed sheets is provided on one side with perforations, particularly elongated holes into which the fingers or binding tongues provided for the loop binding are inserted by the binding apparatus.

Preferably, the binding apparatus has a feed station for feeding individual fingers designed as binding fingers to the sheet stack disposed in the cassette and provided with perforations. Within the scope of the invention, a plurality of fingers can be supplied simultaneously to the sheet stack to be bound. Alternatively, a plurality of fingers is supplied sequentially to the perforation holes of the sheet stack, wherein the fingers are appropriately curved in loop-forming manner.

Moreover, according to a further development of the method, on the circulating conveyor, after the binding apparatus and before the delivery station in the conveyance direction of the cassette or the cassettes, the outside of the loops formed by the fingers are printed by means of a printing apparatus or a printing station, and/or at a processing station, the outer sheet, preferably the base sheet, that is connected to the ends of the fingers facing away from the formed loops, is pivoted or is flipped away from the sheet stack.

Preferably, the circulating conveyor is driven clocked or synchronized by using a drive and an assigned control device, so that the cassette or the cassettes disposed on the circulating conveyor are delivered intermittently to the at least one placement device and subsequently to the binding apparatus, and further subsequently to the delivery station. In particular, the effective length of the circulating conveyor is divisible into whole numbers by the step width. The circulating conveyor is preferably designed as a rotary indexing table.

In order to process the sheet stack to be bound at the appropriate stations provided at the circulating conveyor, it is advantageously provided with the method that the angular position of the cassettes disposed on the circulating conveyor is changed in the radial direction during a complete circulation, where the angular position of the cassettes disposed on the circulating conveyor in the area of the binding apparatus is greater, or will be increased relative to the horizontal plane, in comparison to angular position or the angular positions of the cassettes outside of the binding apparatus.

Further, embodiments of the invention are directed to an apparatus or arrangement for producing bound sheet stacks each having flat parts, in particular paper products,
wherein a circulating conveyor is provided with a plurality of cassettes, and the cassettes are designed for receiving one sheet stack each,
wherein a sheet stack dispensing device is provided or disposed adjacent to the circulating conveyor, so that an unbound sheet stack with a plurality of flat parts will be conveyed from the sheet stack dispensing device in a cassette of the circulating conveyor,
wherein a drive is provided for the circulating conveyor so that after receiving the sheet stack, preferably to be bound, in the cassette, the circulating conveyor is driven or will be driven, and the cassette with the received sheet stack is conveyed further,
wherein a binding apparatus is provided adjacent to the circulating conveyor, so that the sheet stack in the cassette will be bound, or will be bound, at the binding apparatus in such a way that fingers, designed as binding tongues, are disposed in perforations of the sheet stack, preferably provided with perforations. The fingers are, or will be, curved in the shape of a spiral, and preferably have an adhesive-free area of the fingers is, in each case, brought, into overlapping contact with an area of the respective finger, preferably are provided with adhesive, and/or have overlapping contact areas of the fingers that will be, or are, bound together, preferably permanently,
and a delivery station is provided disposed downstream in the conveyance direction, adjacent to the circulating conveyor, and is designed or positioned so that bound sheet stack, in particular bound paper products, can be removed, or will be removed, from the cassette.

For this purpose, according to a further development of the apparatus it is proposed that at least one placement device is provided between the sheet stack dispensing device and the binding apparatus, so that via the placement device at least one sheet is added to the sheet stack in the cassette. Preferably, a plurality of placement devices, in particular a cover sheet placement device and/or a base sheet placement device, are disposed preferably sequentially in the conveyance direction of the cassettes.

In particular, a punch tool for rounding one or more corners of the sheet stack to be bound, and/or a spine forming device for shaping the spine of the binder comb, are provided in the conveyance direction of the cassettes before the binding apparatus.

For this purpose, the binding apparatus comprises a feed station for feeding in parallel at least two individual fingers formed as binding tongues, to the sheet stack, disposed in the cassette and formed with perforations.

Furthermore, the apparatus is provided with a printing station after the binding apparatus and before the delivery station in the conveyance direction of the cassettes, so that the outsides of the loops formed by the fingers can be provided with an overprint, or are printed.

For this purpose, a preferred embodiment of the apparatus further provides a pivoting apparatus at a processing station after the binding apparatus and before the delivery station in the conveyance direction of the cassettes, so that the outer sheet, preferably the base sheet of the sheet stack, that is connected to the ends of the fingers facing away from the formed loops, can be, or will be, pivoted away from the sheet stack, preferably by at least 90°, or more than 90°.

In addition, one embodiment of the apparatus provides that the circulating conveyor is designed as a rotary indexing table and by using a drive and an assigned control device is driven clocked or synchronized, wherein in particular the step angle of a step amounts to 15° or a whole number multiple of 15°, preferably 30°. In particular, the circulating conveyor is operated in a clocked manner at a rotary indexing table.

In one embodiment of the apparatus, it is beneficial that the circulating conveyor has an element for changing the angular position of the cassettes and/or that the cassettes have a format adjusting unit for adapting the cassettes to the format of the sheet stack that is bound, or is to be bound. This results in the cassettes being appropriately adapted to the format being processed so that it is possible to produce different formats using the apparatus, while at the same time it is possible to change formats more rapidly.

By the use of the embodiment of the method steps mentioned above and using an apparatus described above, bound flat parts, in particular paper stacks, are produced, for instance as paper products, where an outer sheet has, or is connected to, a plurality of individual fingers disposed separately (end side), preferably parallel and/or next to each other, where the fingers of an outer sheet are disposed in perforations of the flat parts that are disposed stacked, where the finger are rolled up or curved forming spirals and one area of the fingers is brought into overlapping contact with another area of the respective finger, where the fingers in the contact area are permanently connected together in the contact area of the fingers, and where the ends of the individual fingers facing away from the formed loops are connected to an outer sheet, which can be obtained in particular by using the embodiment of the method described above, in particular by using an apparatus described above. To avoid repetition, explicit reference is made to the explanations above for the method and apparatus.

Moreover, it is preferable with the design of the bound flat parts that the ends of the individual fingers are disposed at the inside of the outer sheet. In particular the fingers each engage from behind the webs, preferably formed at an edge or one side of the outer sheet, of the respective perforations provided for the fingers on the outer sheet.

Furthermore, the ends of the individual fingers are preferably disposed at the outer sheet or at the outside of the outer sheet.

For this purpose it is further provided that the outer sheet and the fingers of the outer sheet are composed essentially of the same non-metallic single-layer material and/or have essentially the same thickness.

As a result, it is advantageous in an alternative, preferred further development that the outer sheet and the fingers are made of different, in particular non-metallic, materials and/or have different thicknesses and/or different colors, or that the fingers are made of different, in particular non-metallic, materials and/or have different thicknesses and/or different widths and/or different lengths and/or different colors.

Variable variants that can be easily modified according to the requirements of the bound flat parts to be produced or produced are hereby reached in a simple manner.

Moreover, it is advantageous if the fingers, in particular in the visible area, have an embossing and/or an imprint and/or the fingers, in particular in the joining area with the outer sheet, have at least one creasing crosswise to the longitudinal extension of the fingers.

In a preferred embodiment of the flat parts produced bound as an (end) product, the distance between two binding tongues or fingers is equal to the width of the binding tongues or fingers.

In an alternative, preferred embodiment of the flat parts produced as (end) products, only two or three binding tongues or fingers are provided, the width of which is greater than the distance between the binding tongues or fingers.

It is in particular beneficial when, in the case of the bound flat parts, the outer sheet and the fingers of the outer sheet and the flat parts are made or produced of the same material.

Further characteristics of the invention will become apparent from the description of the embodiments according to the invention together with the claims and the included drawings. Embodiments according to the invention can fulfill individual characteristics or a combination of several characteristics.

### BRIEF DESCRIPTION OF THE DRAWINGS

The invention is described below, without restricting the general idea of the invention, using exemplary embodiments with reference to the drawings, whereby reference is expressly made to the drawings with regard to the disclosure of all details according to the invention that are not explained in greater detail in the text.

FIG. 1 shows a schematic perspective view of paper stack sheets produced and bound as an (end) product;

FIG. 2 shows a schematic cross section through a bound paper sheet stack;

FIG. 3a shows a schematic view of a single screwed in or produced binding loop of a bound paper sheet stack;

FIG. 3b shows a schematic view of a double screwed in or produced binding loop of a bound paper sheet stack;

FIG. 4 shows a schematic cross section through a base sheet with a binding tongue disposed or fastened at one end to the inside;

FIG. 5 shows a schematic top view of an arrangement for producing bound paper products; and

FIG. 6 shows a schematic perspective view of an embodiment of an arrangement for producing bound paper products.

In the following figures, the same or similar types of elements or corresponding parts are provided with the same reference numbers so that a corresponding re-introduction can be omitted.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

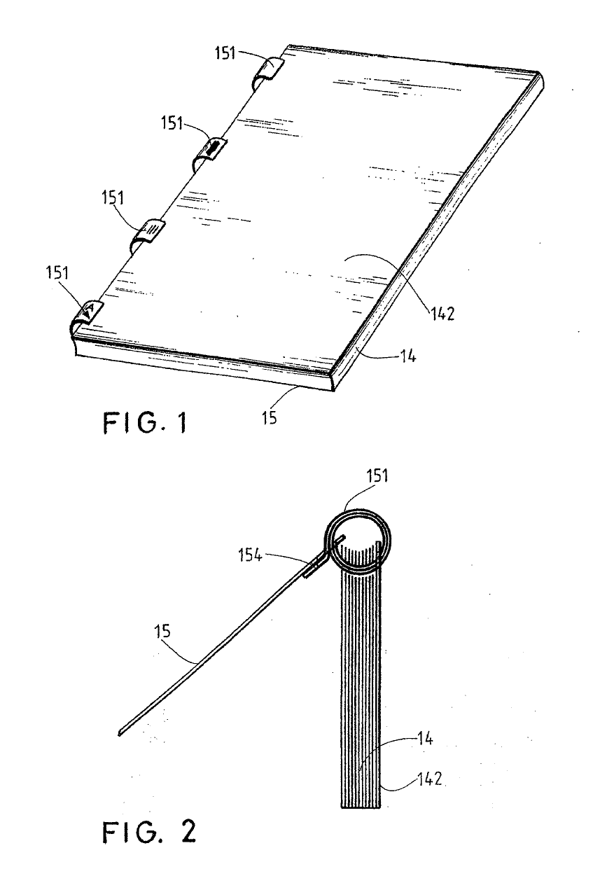

FIG. 1 shows a perspective view of a bound paper stack 14, where the cover sheet 142 is disposed on the top, and the base sheet 15 is disposed on the bottom. The paper stack 14 is permanently bound by the loop-like rolling of the binding tongues 151 into the perforations formed on the side of the paper stack 14. The binding tongues 151 are processed appropriately, for example while being supplied to the base sheet, or to a paper stack 14 to be bound, so that the binding loops 151 are imprinted for example by means of a printing apparatus. Furthermore, it is also possible to die-cut the binding tongues or to provide them with an embossing on the outside by an embossing apparatus.

Depending on the paper stacks 14 to be bound, it is possible that the length and/or the width and/or the thickness of the binding tongues 151 is selected depending on demand, or respectively the length and/or the width and/or the thickness is set accordingly. Moreover, it is also possible to predetermine the color of the binding tongues 151 in order to give the bound product the desired colored appearance.

FIG. 2 shows a schematic cross section of a bound end product, where through the binding, the binding tongue 151 provided with the glue surface 154 is disposed on the inside of the base sheet 15, where the binding tongue 151 is guided through an elongated hole, formed as a perforation in the base sheet 15 so that, for example, after applying glue surfaces 154 to the desired areas of the binding tongues 151, the free ends of the binding tongues 151 are inserted into a stack 14 with a cover sheet 142 and are formed in a loop-like manner.

The pre-punched flat parts of the paper stack, such as sheets of paper, are bound, where the binding loops are disposed or glued in, or on, the base sheet or on the cover sheet or outer sheet. According to the provided binding type, e.g. single loop or double loop, the lengths and the number of binding tongues on the base sheet or cover sheet are cut out and then shaped by a binding loop forming apparatus of a binding apparatus into a loop at the flat part stack or paper stack 14 to be bound, and screwed into the stack of flat parts.

Moreover, it is also possible that the material for the base sheet or the cover sheet of the paper stack with the individual binding tongues subsequently disposed thereon, has substances, such that, after forming a binding loop, the sheet material is exposed to a radiation source in order to reduce the flexibility of the material, whereby the state of the loop is retained and at the same time a firm writing base or the like is attained.

Through the cutting of the binding tongues at a binding apparatus, and the more or less screwing into the binding loop, different loop diameters are created, such that different paper layer thicknesses can be bound with fewer cuts in the base or cover sheets. Furthermore, the formed binding loops are fixed at the transfer point with adhesive after 360°. In this manner, the material bound by the binding loops or respectively the bound stack cannot be removed from the binding loop later on.

Furthermore, it is possible that the outer sheet used (base sheet or cover sheet) is designed in a rounded manner in particular at the locations that are formed for the binding loop. This creates a good gliding behavior through the loop former.

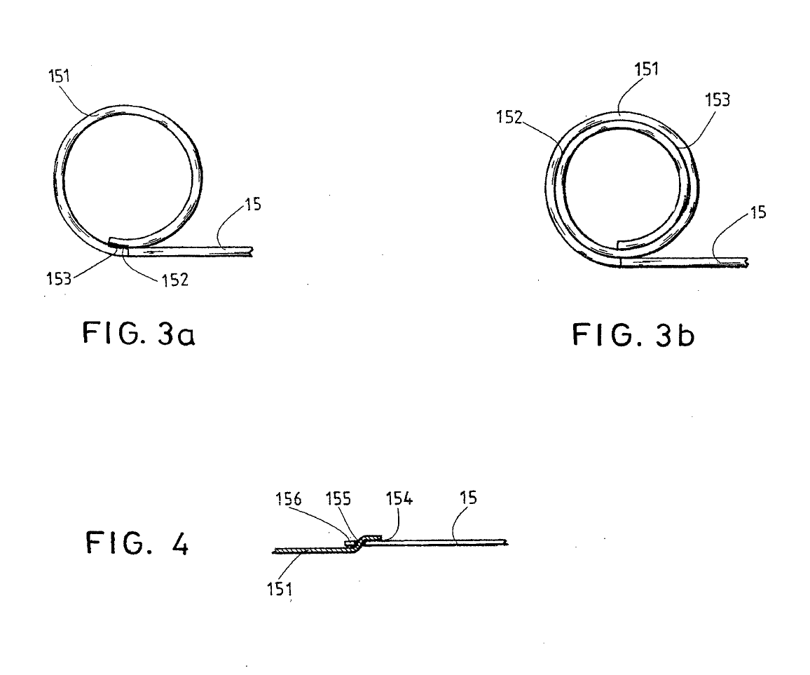

FIG. 3a shows schematically a single screwed in binding loop, with the paper stack 14 omitted. The front end of the binding tongue 151 is designed with a glue trace 152 in an overlapping contact area 153.

FIG. 3b shows a schematic cross-section of a double screwed in or formed binding loop, where the paper stack 14 was also omitted from the drawing for the sake of clarity. The binding loop formed according to FIG. 3b, has a contact area or glue trace 152 with a circumference of 360°. Depending on the material strength of the base sheet 15 or the binding tongues 151, the stability of the formed loops can be increased.

In the double loop according to FIG. 3b, the binding loops produced are formed with a spiral-like cross-section, wherein the contact area or the length of the glue trace is selected or predetermined according to the desired binding loop shape.

FIG. 4 schematically shows a cross section through a base sheet 15, wherein a binding tongue 151 at one end with its end-side glue surface 154 is disposed and thereby connected to the inside of the base sheet 15. As seen in FIG. 4, the binding tongue 151 is guided through an elongated hole 155 in a snake-like or S-like manner. The free end of the binding tongue 151 pointing away from the base sheet 15 is used for the binding of paper stacks.

The binding tongues 151 are designed as separate material strip sections of a predetermined length. The binding tongues 151 in one embodiment can have an embossing or creasing 153 or the like on one end. In addition, the binding tongues 151 on the one end, which is connected with the base sheet 15, have a glue surface 154, to which an adhesive will be or is applied. For fastening or arranging the binding tongues 151 on the base sheet 15, the binding tongues 151 are inserted or pierced into the elongated holes 155. The glue surfaces 154 of the separate binding tongues 151 are disposed individually adhesively on the inside of the base sheet 15, so that the binding tongues 151 with their glue surfaces 154 adhering to the inside of the base sheet 15 engage behind the elongated hole webs 156 formed between the elongated holes 155 and the outer longitudinal edge of the base sheet 15.

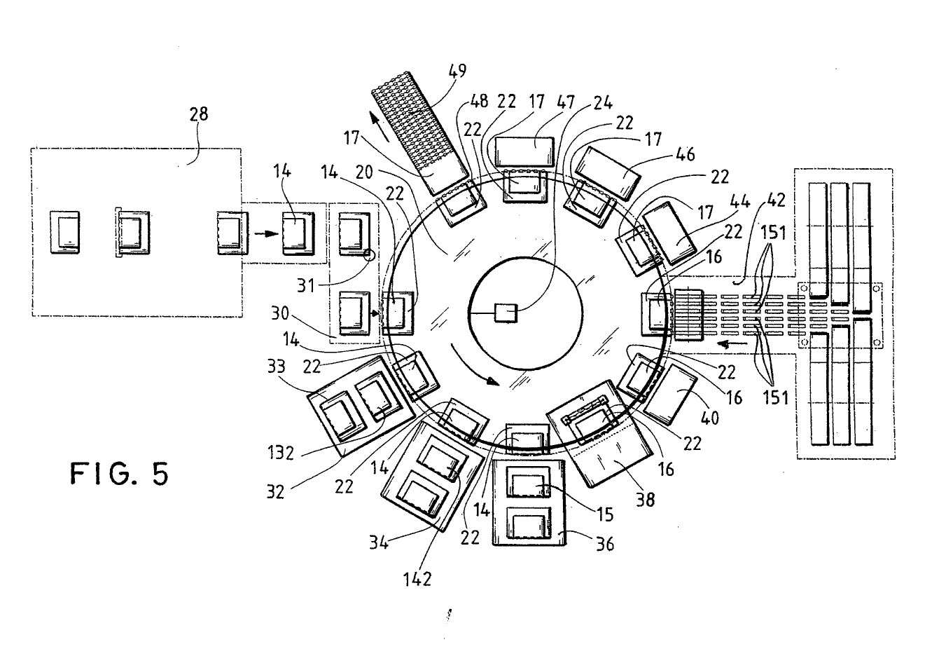

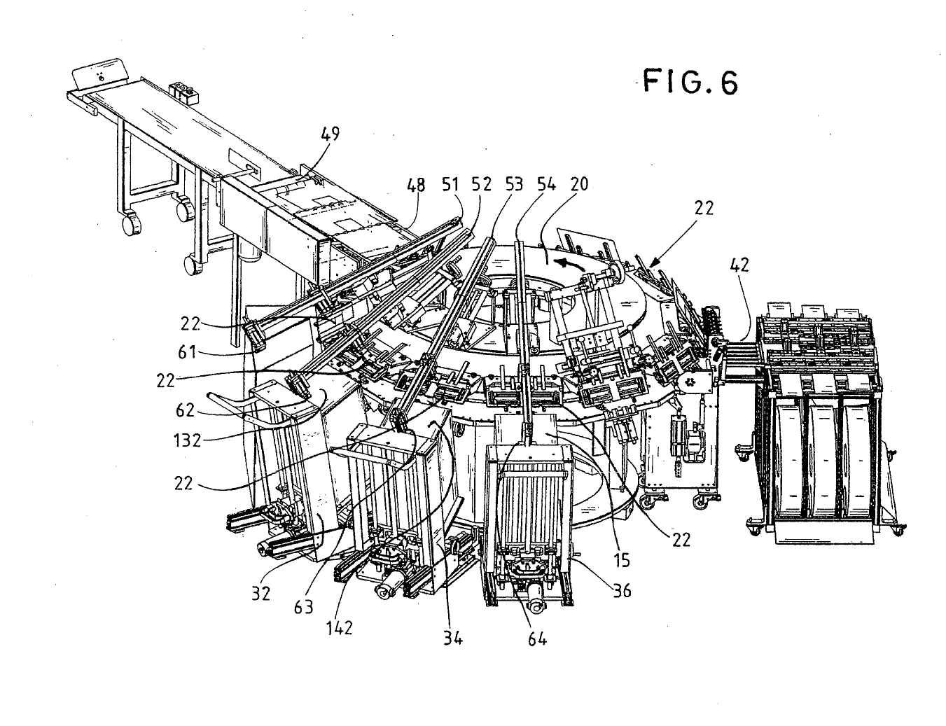

FIG. 5 shows a schematic top view of an arrangement or apparatus for producing bound paper products, such as writing pads or note pads or the like. FIG. 6 schematically shows a perspective representation of one embodiment of the arrangement or apparatus for producing bound paper products, wherein individual apparatuses, stations or working units are omitted for clarity.

The arrangement or apparatus for producing bound paper products has a rotary indexing table 20 that is designed as a circulating conveyor. The rotary indexing table 20 has at its radially outward directed edge region, or in its circumferential direction, cassettes 22 which are disposed at regular distances at the periphery of the rotary indexing table 20.

According to the present example embodiments corresponding to FIGS. 5 and 6, there are twelve receptacles or cassettes 22 which are disposed uniformly at the periphery of the rotary indexing table 20. With this, twelve transfer stations and/or workstations can be positioned at the periphery of the rotary indexing table 20, adjacent to the rotary indexing table 20. Due to the division, an angle of 30°, relative to the axis of rotation of the rotary indexing table 20, results between two adjacent cassettes or transfer stations and/or workstations, or more precisely between their midlines. However, other divisions of the rotary indexing table can also be envisioned corresponding to the number of transfer stations and/or workstations and/or a deviating material flow direction, required in other cases. In this context it is mentioned that the term rotary index table is not limited to a circular contour, rather it comprises in particular also a contour of a regular rectangle or polygon.

The cassettes 22 are designed to receive paper stacks 14 formed as sheet stacks, where a paper stack 14 is comprised of a plurality of flat parts, for instance sheets. The paper stack 14 can also be designated as a sheet stack 14.

A paper stack dispensing device 30 for receiving a paper stack 14 formed from a plurality of paper sheets, is disposed or provided at, or adjacent to, the rotary indexing table 20; this device has a transportation gripper or gripping apparatus 61, for instance a suction gripper, movably supported at a linear unit 51, by which a paper stack 14 is transferred and deposited into a cassette 22. The paper stack dispensing device 30 has a counter 31 (not shown) on the input side, so that a predetermined quantity of a plurality of paper sheets is dispensed as a stack into a cassette 22 of the rotary indexing table 20. The paper stack dispensing device 30 receives the pre-punched paper sheets from a punch 28 that punches perforation holes or elongated holes into the paper sheets to be bound; binding tongues are inserted into the holes in a subsequent work step. According to definition, the paper stack dispensing device 30 is located at the 12 o'clock position.

In a modification of the example embodiment shown according to FIGS. 5 and 6, it can be provided that a punch device is an integral component of the rotary indexing table 20 or of an external workstation downstream in the production flow from the paper stack dispensing device 30; in particular if the paper stacks are provided, particularly with a few sheets, that have no perforation holes or elongated holes.

After receiving a paper stack 14 into the cassette 22, the cassette 22 with a paper stack 14 is delivered in a counter clockwise direction, clock or stepwise to a sheet placement device 32 (11 o'clock position), to a cover sheet placement device 34 (10 o'clock position), and to a base sheet placement device 36 (9 o'clock position).

A sheet, for example an advertisement sheet 132, or an information sheet is placed from a magazine 33 onto the paper stack 14 disposed in the cassette 22, by the sheet placement device 32, which has a gripping apparatus 62, for instance a suction gripper, and is movably supported at a linear unit 52. Following that, after delivering the cassette 22 to the cover sheet placement device 34, a cover sheet 142 is placed from a magazine of the cover sheet placement device 34 onto the stack formed in the cassette 22, via a gripping apparatus 63, for instance a suction gripper, that is movably supported at a linear unit 53.

Subsequently, after a further intermittent advance, the cassette 22 is delivered in the 9 o'clock position to the base sheet placement device 36, so that a base sheet (see FIG. 1, reference number 15) is supplied from a magazine onto the paper stack 14 lying in, or disposed in, the cassette 22, via a gripping apparatus 63, for instance a suction gripper, that is movably supported at a linear unit 54. The advertisement sheet 132, coversheet 142 and base sheet 15 placed on the paper stack 14 are provided on their binding side with perforations, for instance elongated holes or elongated slits, so that the sheets placed on the paper stack 14 and the cassettes 22 become appropriately aligned with the perforation holes 155 of the paper stack 14.

The perforation holes are formed here in particular as elongated holes or elongated slits, wherein a type of slit-like channel is formed by the perforation holes in the block-wise arrangement, or stack-wise arrangement of the plurality of paper sheets or the paper stack 14 and the sheet stack 16 formed from the placed sheets 132, 142, 15.

After the base sheet placement device 36, the cassette with this sheet stack 16 to be bound is subsequently transported to a corner rounding apparatus 38, wherein the corners, for instance the front side corners of a sheet stack 16, are rounded by means of a punch tool. Subsequently, the sheet stack 16 is conveyed to a spine forming apparatus 40. In this way, the spine of the sheet stack 16 is preformed concave so that subsequently the preformed sheet stack 16 in the cassette 22 is delivered to the binding apparatus 42 for binding.

In a modification of the example embodiments shown according to FIGS. 5 and 6, it can be provided that the corner rounding apparatus has a further punch tool for creating perforation holes, namely in the case that paper stacks and/or the advertisement sheet and/or cover sheets and/or base sheets are provided without perforations.

At the binding apparatus 42, individual binding tongues 151 are conveyed simultaneously and in parallel by a cam or finger conveyor belt into the perforation holes of the sheet stack 16 at the binding apparatus 42, so that the binding tongues 151 during insertion into the sheet stack 16 to be bound are curved in the shape of a spiral. A preferably adhesive-free area of the binding tongue 151 is, in each case, brought into overlapping contact with an area of the respective binding tongue 151 preferably provided with adhesive, so that the binding tongues form a spiral shaped loop (see FIG. 2, 3a, 3b).

Following this, the sheet stack 16 in the cassette 22, bound with the spiral shaped loops, is delivered to a connecting device 44 so that for example the free ends of the binding tongues 151 are connected or glued to the base sheet 15 disposed on the sheet stack 16. Subsequently, the bound paper product 17 in the cassette 22 is delivered to an optional printing apparatus 46 and further subsequently to a delivery station 48 so that after turning the base sheet 15 bound with the binding tongues 151 (see FIG. 2), the bound paper products are placed on a conveyor belt 49, wherein the speed of the conveyor belt is selected so that an overlapping stream of products is formed on the conveyor belt 49.

At the delivery station 48, the bound products or paper products 17 are each removed from the cassettes 22 by one or more mechanical and/or pneumatic grippers, preferably suction grippers, so that the empty cassettes 22 are then delivered to the paper stack dispensing device 30.

While conveying the cassettes 22 in the area of the spine forming apparatus 40 and the binding apparatus 42, as well as the connecting apparatus 44, the incline of the cassettes 22 is increased, whereby the binding processes for binding the paper stacks 14 are improved.

Furthermore, the cassettes 22 have corresponding format adjusting elements in order to accept different formats of paper products to be bound. In addition, a station 47 can be provided between the printing apparatus 46 and the delivery station 48 in order to pivot, for example a base sheet 15 lying on top of the paper stack 14, so that it is easier to deliver the bound paper products 17 at the delivery station 48.

The rotary indexing table 20 is operated clocked or stepwise in recirculating operation. A controllable drive 24 is provided for the rotary indexing table 20 that moves the rotary indexing table 20 along with the cassettes 22 by 30° in each case to the individual stations, so that the cassettes remain there for a predetermined duration of time for the purpose of transferring or processing the (intermediate) product.

All named features, including those taken from the drawings alone, and individual features, which are disclosed in combination with other features, are considered individually and in combination as essential to the invention. Embodiments according to the invention can be fulfilled through individual characteristics or a combination of several characteristics.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE SYMBOLS

14 paper stack/sheet stack

15 base sheet

16 sheet stack

17 bound paper product

20 rotary indexing table

22 cassette

24 drive

28 punch

30 paper stack dispensing device

31 counter

32 sheet placement device

33 magazine

34 cover sheet placement device

36 base sheet placement device

38 corner rounding apparatus

40 spine forming apparatus

42 binding apparatus

44 connecting device

45 printing station

46 printing apparatus

47 station

48 delivery station

49 conveyor belt

51 linear unit

52 linear unit

53 linear unit

54 linear unit

61 gripper apparatus

62 gripper apparatus

63 gripper apparatus

64 gripper apparatus

132 advertisement sheet

142 cover sheet

151 binding tongue

152 glue trace

153 contact area

154 adhesive surface

155 elongated hole

156 elongated hole web

1.-15. (canceled)

16. A method for producing bound flat parts, each having a sheet stack, the method comprising:
conveying an unbound sheet stack from a sheet stack dispensing device into a cassette of a circulating conveyor, so that the sheet stack to be bound is received into the cassette,
after receiving the sheet stack to be bound in the cassette, driving a circulating conveyor so that the cassette with the sheet stack to be bound is conveyed further to be delivered to a binding apparatus,
binding the sheet stack in the cassette at the binding apparatus so that fingers formed as binding tongues are disposed in perforations of the sheet stack so that the fingers are curved in the shape of a spiral, wherein at least one of:
an adhesive-free area of each finger is brought into overlapping contact with an area of the respective finger,
an adhesive-free area of each finger is brought into overlapping contact with an area of the respective finger provided with adhesive, and
overlapping contact areas of the fingers are bound together;
removing at a dispensing station the bound sheet stack from the cassette; and
delivering the empty cassette to the sheet stack dispensing device.

17. The method in accordance with claim 16, wherein the bound flat parts comprise paper products; and the overlapping contact areas are permanently bound together.

18. The method in accordance with claim 16, wherein after the cassette receives a sheet stack to be bound and before delivering the cassette to the binding apparatus, the method further comprises delivering the cassette to at least one placement device to add at least one sheet to the sheet stack,
wherein the at least one placement device comprises at least one of a cover sheet placement device for placing a cover sheet and a base sheet placement device for placing a base sheet.

19. The method in accordance with claim 18, wherein the at least one placement device comprises the cover sheet placement device and the base sheet placement device, and the cassette is sequentially delivered to the cover sheet placement device and the base sheet placement device in order to sequentially place a cover sheet and a base sheet in the cassette.

20. The method in accordance with claim 16, wherein before delivery to the binding apparatus, the method further comprises at least one of:
rounding at least one corner of the sheet stack to be bound in the cassette; and
preforming the sheet stack at its spine.

21. The method in accordance with claim 16, wherein the binding apparatus has a supply station for supplying the fingers formed as binding tongues to the sheet stack, and the method further comprises:
inserting the fingers into the perforations of the sheet stack;
curving the fingers into spiral shapes; and
at least one of:
bringing one area of the fingers into overlapping contact with another area of a respective finger to form a loop,
permanently connecting the fingers together in the contact area of the fingers, and
wherein the ends of the fingers facing away from the formed loops are bound to the outer sheet in one of a simultaneous or subsequent operation.

22. The method in accordance with claim 21, further comprising printing outsides of the loops formed by the fingers via at least one of a printing apparatus, a printing station, and a processing station, wherein the outer sheet connected to the ends of the fingers is pivoted or is flipped away from the sheet stack.

23. The method in accordance with claim 18, wherein the driving of the circulating conveyor is achieved through a drive and an assigned control device, so that cassettes disposed on the circulating conveyor are delivered intermittently to the at least one placement device and subsequently to the binding apparatus, and further subsequently to the delivery station,
wherein an effective length of the circulating conveyor is divisible into whole numbers by a step width.

24. The method in accordance with claim 16, wherein an angular position of the cassettes disposed on the circulating conveyor changes in the radial direction during a complete circulation, wherein the angular position of the cassettes disposed on the circulating conveyor in the area of the binding apparatus is greater, relative to the horizontal plane, than an angular position of the cassettes outside of the binding apparatus.

25. An apparatus for producing bound flat parts, each having a sheet stack, comprising:
a circulating conveyor provided with a plurality of cassettes, each structured and arranged for receiving one sheet stack;
a sheet stack dispensing device positioned adjacent to the circulating conveyor to convey an unbound sheet stack in a cassette of the circulating conveyor;
a drive is provided for conveying the circulating conveyor so that after receiving the sheet stack in the cassette, the circulating conveyor is driven and the cassette with the received sheet stack is conveyed;
a binding apparatus arranged adjacent to the circulating conveyor to bind the sheet stack in the cassette in such a way that fingers, designed as binding tongues, are disposed in perforations of the sheet stack so that the fingers are curved in the shape of a spiral, wherein at least one of:
an adhesive-free area of each finger is brought into overlapping contact with an area of the respective finger,
an adhesive-free area of each finger is brought into overlapping contact with an area of the respective finger provided with adhesive, and
overlapping contact areas of the fingers are bound together;
removing at a dispensing station the bound sheet stack from the cassette; and
a delivery station arranged downstream in the conveyance direction and adjacent to the circulating conveyor, at which bound sheet stacks are removable from the cassettes.

26. The apparatus in accordance with claim 25, wherein the bound flat parts comprise paper products; and the overlapping contact areas are permanently bound together.

27. The apparatus in accordance with claim 25, further comprising at least one placement device arranged between the stack dispensing device and the binding apparatus to add at least one sheet to the sheet stack in the cassette.

28. The apparatus in accordance with claim 27, wherein the at least one placement device comprises a plurality of placement devices including a cover sheet placement device and a base sheet placement device sequentially arranged in the conveyance direction of the cassettes.

29. The apparatus in accordance with claim 25, further comprising at least one of a punch tool for rounding one or more corners of the sheet stack to be bound and a spine forming device for shaping the spine of the sheet stack arranged before the binding apparatus in the conveyance direction of the cassettes.

30. The apparatus in accordance with claim 25, wherein the binding apparatus has a supply station for supplying in parallel at least two individual fingers formed as binding tongues to the perforations of the sheet stack in the cassette.

31. The apparatus in accordance with claim 25, wherein a printing station with a printing apparatus is arranged in the conveyance direction of the cassettes after the binding apparatus and before the delivery station to provide the outsides of the loops formed by the fingers with an overprint.

32. The apparatus in accordance with claim 25, further comprising a pivoting apparatus arranged at a processing station in the conveyance direction of the cassettes on the circulating conveyor after the binding apparatus and before the delivery station to pivot the outer sheet, to which ends of the fingers facing away from the formed loops are bound, away from the sheet stack.

33. The apparatus in accordance with claim 32, wherein the outer sheet comprises a base sheet of the sheet stack, and the outer sheet is pivoted one of at least 90° or more than 90°.

34. The apparatus in accordance with claim 25, further comprises a drive and an assigned control device, wherein the circulating conveyor is formed as a rotary indexing table and the drive and the assigned control device are arranged to drive the circulating conveyor at one of a step angle 15°, a whole number multiple of 15°, and 30°.

35. The apparatus in accordance with claim 25, further comprising at least one of an angular positioning element structured and arranged to change the angular position of the cassettes and a format adjusting unit structured and arranged to adapt the cassettes to the format of the sheet stack to be bound.
